(19) United States
(12) Patent Application Publication
(10) Pub. No.: US 2021/0151946 A1
(43) Pub. Date: May 20, 2021

(54) LASER PROCESSOR AND LASER BEAM MACHINE

(71) Applicant: Mitsubishi Electric Corporation, Tokyo (JP)

(72) Inventors: Tomohiro KYOTO, Tokyo (JP); Taira OGITA, Tokyo (JP); Takeshi MORIMOTO, Tokyo (JP); Hideyasu MACHII, Tokyo (JP); Hiroaki KUROKAWA, Tokyo (JP)

(73) Assignee: Mitsubishi Electric Corporation, Tokyo (JP)

(21) Appl. No.: 17/048,608

(22) PCT Filed: Apr. 24, 2018
(86) PCT No.: PCT/JP2018/016667

§ 371 Date: Oct. 19, 2020

(51) Int. Cl. H01S 3/00; H01S 3/09; H01S 3/04; B23K 26/062

(52) U.S. Cl. CPC H01S 3/0014; B23K 26/062; H01S 3/0407; H01S 3/09

(57) ABSTRACT

A laser processor includes a laser oscillator housed in a closed housing, an oscillator controller that controls the laser oscillator and is supplied with electric power by a first primary power supply, a dehumidifier that is housed in the closed housing and operates using electric power supplied from a second primary power supply, and a dehumidification controller that controls the dehumidifier and is supplied with electric power by the second primary power supply.

### FIELD

The present invention relates to a laser processor including a dehumidifying apparatus and also relates to a laser beam machine.

### BACKGROUND

A conventional laser processor disclosed in Patent Literature 1 includes a dehumidifying apparatus within itself, and the dehumidifying apparatus performs dehumidification while a laser oscillator that outputs a laser beam is driven. In this conventional laser processor, a controller that functions as an oscillator controller to control the laser oscillator, and the dehumidifying apparatus are supplied with electric power by a primary power supply.

### CITATION LIST

### Patent Literature

Patent Literature 1: Japanese Patent Application Laid-open No. 2017-5141

### SUMMARY

### Technical Problem

However, in Patent Literature 1 describing the above conventional technique, since the oscillator controller and the dehumidifying apparatus are supplied with electric power by their common commercial power supply via a breaker, the dehumidifying apparatus stops at the same time as an interruption is performed for some reason by the breaker while the laser processor is in operation. Therefore, cooling water remaining in the laser oscillator problematically causes condensation in the laser oscillator.

The present invention has been made in view of the above, and an object of the present invention is to obtain a laser processor that enables prevention of condensation in a laser oscillator even when interruption of electric power to an oscillator controller takes place.

### Solution to Problem

To solve the above-stated problem and achieve the object, a laser processor according to the present invention includes: a laser oscillator housed in a housing; and an oscillator controller that controls the laser oscillator and is supplied with electric power by a first primary power supply. The laser processor according to the present invention also includes: a dehumidifier that is housed in the housing and operates using electric power supplied from a second primary power supply, and a dehumidification controller that controls the dehumidifier and is supplied with electric power by the second primary power supply.

### Advantageous Effects of Invention

The laser processor according to the present invention enables prevention of condensation in the laser oscillator even when interruption of electric power to the oscillator controller takes place.

### BRIEF DESCRIPTION OF DRAWINGS

FIG. 1 illustrates a first configuration example of a laser processor according to a first embodiment.

FIG. 2 illustrates a second configuration example of the laser processor according to the first embodiment.

FIG. 3 illustrates a configuration example of a laser processor according to a second embodiment.

FIG. 4 illustrates a configuration example of a laser processor according to a third embodiment.

FIG. 5 illustrates a configuration example of a laser beam machine according to the first through third embodiments.

### DESCRIPTION OF EMBODIMENTS

With reference to the drawings, a detailed description is hereinafter provided of laser processors and laser beam machines according to embodiments of the present invention. It is to be noted that these embodiments are not restrictive of the present invention.

### First Embodiment

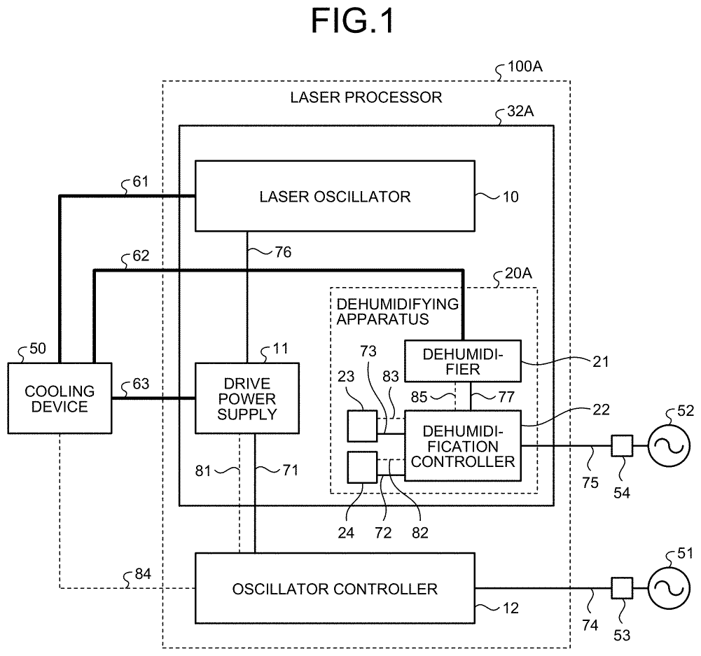

FIG. 1 illustrates a first configuration example of a laser processor according to the first embodiment. A laser processor 100A is an apparatus that outputs a laser beam. The laser processor 100A includes: a water-cooled laser oscillator 10 that produces a laser beam; a drive power supply 11; an oscillator controller 12; and a dehumidifying apparatus 20A. The laser oscillator 10, the drive power supply 11, the oscillator controller 12, and the dehumidifying apparatus 20A of the laser processor 100A are covered by an exterior cover. The laser oscillator 10, the drive power supply 11, and the dehumidifying apparatus 20A of the laser processor 100A are housed in a hermetically sealed condition in a closed housing 32A. The laser processor 100A is connected to a cooling device 50, a first primary power supply 51, and a second primary power supply 52. The first primary power supply 51 and the second primary power supply 52 are commercial power supplies.

The first primary power supply 51 is connected to the oscillator controller 12 via a power line 74 to supply, to the oscillator controller 12 by way of the power line 74, electric power that drives the oscillator controller 12, the drive power supply 11, and the laser oscillator 10. The first primary power supply 51 is connected to the oscillator controller 12 via a first breaker 53.

The second primary power supply 52 is connected to the dehumidifying apparatus 20A via a power line 75 to supply, to the dehumidifying apparatus 20A by way of the power line 75, electric power that drives the dehumidifying apparatus 20A. The second primary power supply 52 is connected to the dehumidifying apparatus 20A via a second breaker 54.

The cooling device 50 is a device that water-cools the laser oscillator 10, the drive power supply 11, and the dehumidifying apparatus 20A. The cooling device 50 is connected: to the laser oscillator 10 via piping 61; to the dehumidifying apparatus 20A via piping 62; and to the drive power supply 11 via piping 63. The piping 61, the piping 62, and the piping 63 each includes a pipe that conveys water from the cooling device 50 to the laser processor 100A, and a pipe that conveys the water from the laser processor 100A to the cooling device 50. The cooling device 50 cools the water conveyed from the laser processor 100A for delivery to the laser processor 100A.

The drive power supply 11 is a secondary power supply and is connected to the laser oscillator 10 via a power line 76. The drive power supply 11 supplies electric power that drives the laser oscillator 10 to the laser oscillator 10 by way of the power line 76.

The oscillator controller 12 is connected to the drive power supply 11 via a power line 71 to supply electric power, which drives the drive power supply 11 and the laser oscillator 10, to the drive power supply 11 by way of the power line 71. The oscillator controller 12 and the drive power supply 11 are also connected via a signal line 81 to each transmit a signal and receive a signal by way of the signal line 81. The oscillator controller 12 transmits to the drive power supply 11 by way of the signal line 81 the signal that controls the drive power supply 11, while the drive power supply 11 transmits to the oscillator controller 12 by way of the signal line 81 the signal indicative of a state of the drive power supply 11. The oscillator controller 12 and the cooling device 50 are connected via a signal line 84 to each transmit a signal and receive a signal by way of the signal line 84. The oscillator controller 12 transmits to the cooling device 50 by way of the signal line 84 the signal that controls the cooling device 50, while the cooling device 50 transmits to the oscillator controller 12 by way of the signal line 84 the signal indicative a state of the cooling device 50.

The oscillator controller 12 controls the drive power supply 11, thus controlling the laser oscillator 10. The oscillator controller 12 also controls the cooling device 50.

The dehumidifying apparatus 20A is disposed inside the closed housing 32A and performs dehumidification inside the closed housing 32A. The dehumidifying apparatus 20A includes: a dehumidifier 21 that performs dehumidification; a dehumidification controller 22 that controls the dehumidifier 21; a temperature sensor 23 that performs temperature measurement; and a humidity sensor 24 that performs humidity measurement.

The dehumidification controller 22 is connected to the dehumidifier unit 21 via a power line 77 to supply electric power, which drives the dehumidifier unit 21, to the dehumidifier unit 21 by way of the power line 77. Moreover, the dehumidification controller 22 is connected to the dehumidifier 21 via a signal line 85 to transmit a signal, which controls the dehumidifier unit 21, to the dehumidifier unit 21 by means of the signal line 85.

The dehumidification controller 22 is also connected to the humidity sensor 24 via a power line 72 to supply electric power, which drives the humidity sensor 24, to the humidity sensor 24 by way of the power line 72. With this configuration, the humidity sensor 24 is electrically powered by the second primary power supply 52 similarly to the dehumidifier 21. The dehumidification controller 22 and the humidity sensor 24 are also connected via a signal line 82 to each transmit a signal and receive a signal by way of the signal line 82. The dehumidification controller 22 transmits the signal that controls the humidity sensor 24 to the humidity sensor 24. The humidity sensor 24 measures internal humidity of the closed housing 32A and transmits a humidity measurement result to the dehumidification controller 22.

The dehumidification controller 22 is also connected to the temperature sensor 23 via a power line 73 to supply electric power that drives the temperature sensor 23 to the temperature sensor 23 by way of the power line 73. With this configuration, the temperature sensor 23 is electrically powered by the second primary power supply 52 similarly to the dehumidifier 21. The dehumidification controller 22 and the temperature sensor 23 are also connected via a signal line 83 to each transmit a signal and receive a signal by way of the signal line 83. The dehumidification controller 22 transmits the signal that controls the temperature sensor 23 to the temperature sensor 23. The temperature sensor 23 measures internal temperature of the closed housing 32A and transmits a temperature measurement result to the dehumidification controller 22.

On a basis of the temperature measurement result and the humidity measurement result, the dehumidification controller 22 controls the dehumidifier 21. On the basis of the temperature measurement result, the dehumidification controller 22 performs feedback control of the dehumidifier 21 to cause the internal temperature of the closed housing 32A to approximate a preset temperature. On the basis of the humidity measurement result, the dehumidification controller 22 performs feedback control of the dehumidifier 21 to cause the internal humidity of the closed housing 32A to approximate a preset humidity.

It is to be noted that temperature sensor 23 may be disposed outside the dehumidifying apparatus 20A as far as the temperature sensor 23 is disposed inside the closed housing 32A. The humidity sensor 24 may be disposed outside the dehumidifying apparatus 20A as far as the humidity sensor 24 is disposed inside the closed housing 32A. The laser processor 100A may not include the temperature sensor 23. The laser processor 100A may not include the humidity sensor 24. The dehumidification controller 22 may be disposed outside the closed housing 32A. In place of the closed housing 32A, a housing that houses the laser oscillator 10, the drive power supply 11, and the dehumidifying apparatus 20A in an unsealed condition may be used.

As described above, the dehumidifying apparatus 20A of the laser processor 100A is electrically powered by the second primary power supply 52, which is different from the first primary power supply 51 that electrically powers the oscillator controller 12, the drive power supply 11, and the laser oscillator 10. The temperature sensor 23 and the humidity sensor 24 are also electrically powered by the second primary power supply 52.

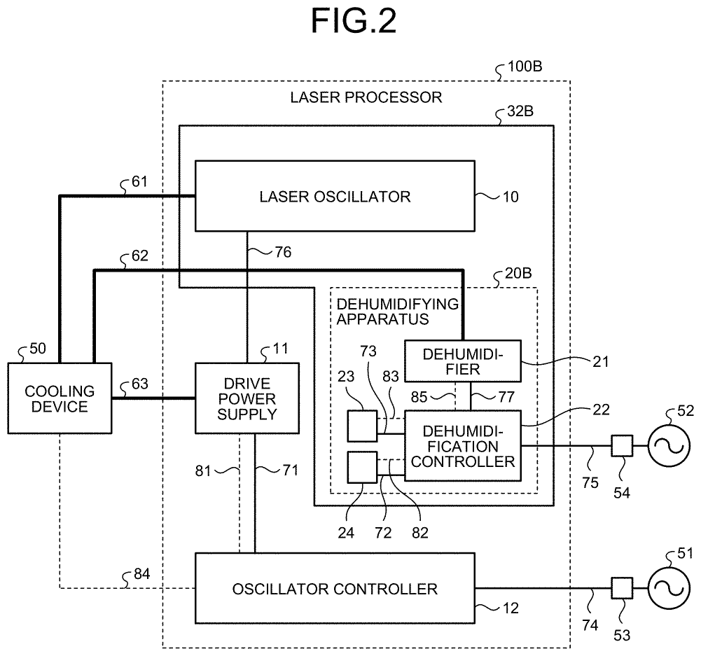

FIG. 2 illustrates a second configuration example of the laser processor according to the first embodiment. In FIG. 2, constituent elements that are functionally identical with those of the laser processor 100A illustrated in FIG. 1 have the same reference characters and are not described in order to omit redundancy.

A laser processor 100B illustrated in FIG. 2 is an apparatus that is functionally similar to the laser processor 100A. The laser processor 100B includes a closed housing 32B in place of the closed housing 32A. The closed housing 32B covers the laser oscillator 10 and a dehumidifying apparatus 20B but does not cover the drive power supply 11. The second primary power supply 52 is connected to the dehumidifying apparatus 20B via the second breaker 54.

The drive power supply 11 may be water-cooled or air-cooled. The closed housing 32B is applicable to cases where the drive power supply 11 is used in an environment where no condensation takes place with a preset temperature being higher. In other words, if the drive power supply 11 is in the environment where no condensation takes place, the drive power supply 11 does not need to be housed in the closed housing 32B. If, on the other hand, the drive power supply 11 has condensation with the closed housing 32B being applied, the closed housing 32A is applied.

As described above, in the first embodiment, the first primary power supply 51 electrically powers the oscillator controller 12, the drive power supply 11, and the laser oscillator 10, while the second primary power supply 52 electrically powers the dehumidifying apparatus 20A. Since the dehumidifying apparatus 20A can be operated independently of the oscillator controller 12, the drive power supply 11, and the laser oscillator 10 in this way, internal humidity control of the laser processor 100A or 100B can be independent of the oscillator controller 12, the drive power supply 11, and the laser oscillator 10. Even if, for example, the first breaker 53 interrupts the electric power to the oscillator controller 12 for some reason while the laser processor 100A or 100B is in operation, the second breaker 54 performs no interruption, enabling the dehumidifying apparatus 20A to use the electric power being supplied from the second primary power supply 52 for dehumidification. Therefore, condensation can be prevented in the laser oscillator 10. Even while the laser oscillator 10 is inactive, the dehumidifying apparatus 20A or 20B can operate and thus enables activation of the laser oscillator 10 at a desired humidity. For this reason, the laser oscillator 10 can be activated in a short time when being started up after having been inactive for a long time period. In other words, even when the laser oscillator 10 has been inactive, the laser oscillator 10 can be activated at a desired timing because no waiting time is required until a humidity in a permissible range, which is a specification range, is reached.

Since the temperature sensor 23 and the humidity sensor 24 are operated independently of the oscillator controller 12, even when the oscillator controller 12 is not in operation, the dehumidification controller 22 can perform feedback control of the dehumidifier 21 on the basis of the temperature detected by the temperature sensor 23 and the humidity detected by the humidity sensor 24.

### Second Embodiment

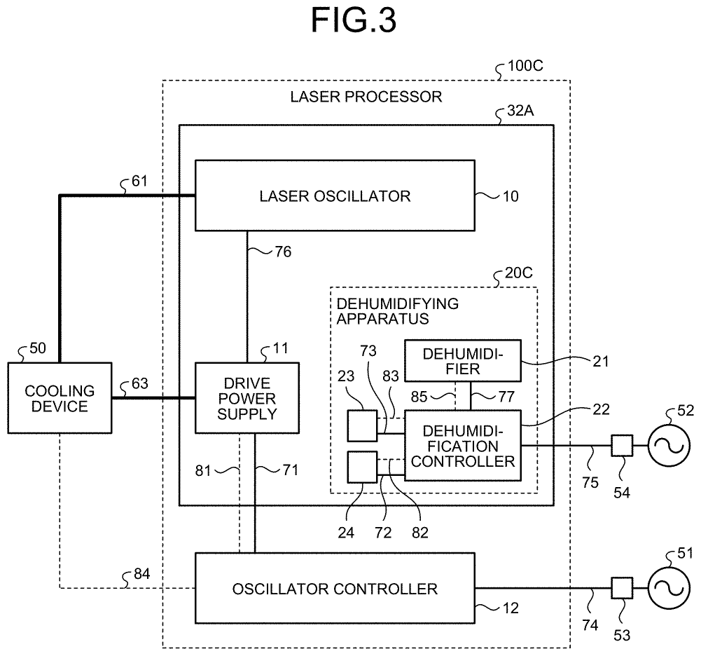

With reference to FIG. 3, a description is provided next of the second embodiment of the present invention. In the second embodiment, an air-cooled dehumidifying apparatus is applied to a laser processor.

FIG. 3 illustrates a configuration example of the laser processor according to the second embodiment. In FIG. 3, constituent elements that are functionally identical with those of the first embodiment's laser processor 100A illustrated in FIG. 1 have the same reference characters and are not described in order to omit redundancy.

The laser processor 100C illustrated in FIG. 3 is an apparatus that is functionally similar to the laser processor 100A. The laser processor 100C includes the air-cooled dehumidifying apparatus 20C in place of the dehumidifying apparatus 20A. In other words, the dehumidifier 21 of the dehumidifying apparatus 20C includes an air-cooled dehumidification mechanism. The dehumidifying apparatus 20C is air-cooled and thus requires no water from the cooling device 50. Accordingly, the laser processor 100C does not include the piping 62. The second primary power supply 52 is connected to the dehumidifying apparatus 20C via the second breaker 54.

It is to be noted that the laser processor 100C may include the closed housing 32B in place of the closed housing 32A. In other words, the laser processor 100B may include the air-cooled dehumidifying apparatus 20C in place of the dehumidifying apparatus 20A.

According to the second embodiment described above, the dehumidifying apparatus 20C of the laser processor 100C is air-cooled, so that even when the cooling device 50 is not in operation, the dehumidifying apparatus 20C can be operated independently.

### Third Embodiment

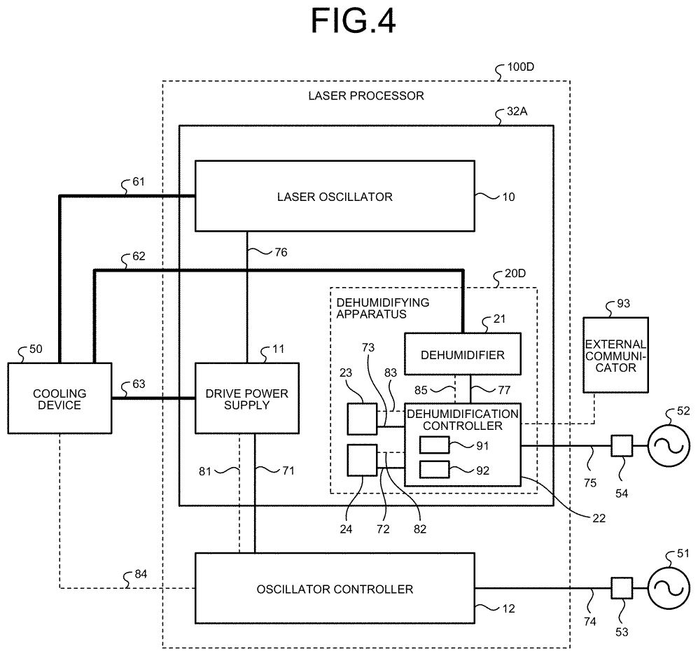

With reference to FIG. 4, a description is provided next of the third embodiment of the present invention. In the third embodiment, a dehumidifying apparatus includes a scheduling function with which the dehumidifying apparatus starts to operate at a specified time, and a timer function with which the dehumidifying apparatus stops operating at a specified time. Moreover, in the third embodiment, an external communicator connected to the dehumidifying apparatus includes a remote control function to remotely control the dehumidifier 21. The dehumidifying apparatus according to the third embodiment performs dehumidification according to an instruction from the external communicator including the remote control function.

FIG. 4 illustrates a configuration example of a laser processor according to the third embodiment. In FIG. 4, constituent elements that are functionally identical with those of the first embodiment's laser processor 100A illustrated in FIG. 1 have the same reference characters and are not described in order to omit redundancy.

The laser processor 100D illustrated in FIG. 4 includes the dehumidifying apparatus 20D in place of the dehumidifying apparatus 20A. The dehumidifying apparatus 20D may be water-cooled or air-cooled. When the dehumidifying apparatus 20D is water-cooled, the dehumidifying apparatus 20D is functionally identical with the dehumidifying apparatus 20A. When the dehumidifying apparatus 20D is air-cooled, the dehumidifying apparatus 20D is functionally identical with the dehumidifying apparatus 20C. The second primary power supply 52 is connected to the dehumidifying apparatus 20D via the second breaker 54.

The dehumidification controller 22 of the dehumidifying apparatus 20D communicates with the external communicator 93 disposed outside the laser processor 100D. The communication between the dehumidification controller 22 and the external communicator 93 may be wireless communication or wired communication. The external communicator 93 is, for example, a remote controller.

The dehumidification controller 22 controls the dehumidifier 21 according to an instruction which is sent from the external communicator 93. Examples of the instruction that the external communicator 93 sends to the dehumidification controller 22 include: an instruction that causes activation of the dehumidifying apparatus 20D; an instruction that causes activation of the dehumidifying apparatus 20D after elapse of a specified time period; and an instruction that causes the dehumidifying apparatus 20D to stop after elapse of a specified time period.

The dehumidifying apparatus 20D includes a scheduler 91 and a timer 92. The scheduler 91 causes the dehumidifier 21 to start dehumidification at a first preset date and time. The scheduler 91 has the first date and time preset by a user. The timer 92 causes the dehumidifier 21 to stop operating at a second preset date and time. The timer 92 has the second date and time preset by the user.

It is to be noted that the laser processor 100D may include the closed housing 32B in place of the closed housing 32A. In other words, the laser processor 100B may include the dehumidifying apparatus 20D in place of the dehumidifying apparatus 20B. The laser processor 100D may not include any of the scheduler 91, the timer 92, and the external communicator 93.

According to the third embodiment described above, the scheduler 91 can activate the dehumidifying apparatus 20D in advance before the laser oscillator 10 that has been inactive for a long time period is started up. Since a humidity in a specification range can be achieved in this way before the laser oscillator 10 is activated, the laser oscillator 10 can be activated in a short time. When continued operation of the dehumidifying apparatus 20D is unnecessary, it suffice to start operation of the dehumidifying apparatus 20D before a specified time of the activation of the laser oscillator 10, thus enabling reduced power consumption as compared to when the dehumidifying apparatus 20D continues operating.

When the laser oscillator 10 is ramped down, immediately after the cooling device 50 is stopped, the operation of the dehumidifying apparatus 20D is maintained while in a low temperature state to prevent condensation, and the dehumidifying apparatus 20D can be stopped by the timer 92 when condensation is less likely to take place. Thus there can be less wasted dehumidification and less power consumption when the laser oscillator 10 is made inactive for a long time.

With operation of the external communicator 93, the dehumidifying apparatus 20D can be activated even at a distance from the laser processor 100D, so that the dehumidifying apparatus 20D can be readily operated before the laser oscillator 10 is started up. Therefore, start-up time of the laser oscillator 10 can be reduced.

Connecting the external communicator 93 to another device enables operation of the dehumidifying apparatus 20D in conjunction with the other device before the laser oscillator 10 is started up. Therefore, the start-up time of the laser oscillator 10 can be reduced.

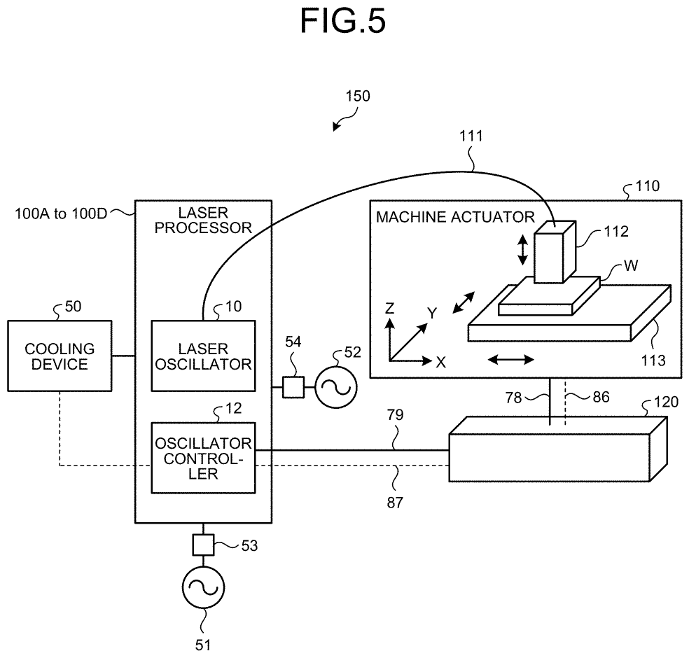

A description is provided here of a configuration of a laser beam machine that includes any of the laser processors 00A to 100D. FIG. 5 illustrates the configuration example of the laser beam machine according to the first through third embodiments. The laser beam machine 150 includes: any one of the laser processors 100A to 100D; the cooling device 50; the first primary power supply 51; the second primary power supply 52; a transmission fiber 111; a machine actuator 110, which is a machining processor; and a machine controller 120. The laser beam machine 150 that is described here includes the laser processor 100A.

The laser oscillator 10 of the laser processor 100A is connected to the transmission fiber 111 that transmits a laser beam to send the laser beam to the machine actuator 110 by way of the transmission fiber 111.

The machine actuator 110 uses the laser beam that is sent from the laser processor 100A to machine a workpiece W which is a piece to be machined. The machine actuator 110 includes a machining head 112 and a work table 113.

The machining head 112 is connected to the laser oscillator 10 via the transmission fiber 111 and irradiates the workpiece W with the laser beam that is sent from the laser oscillator 10 through the transmission fiber 111. The machining head 112 is movable along a Z axis which is directed vertically. The work table 113 is a table on which the workpiece W is placed. The work table 113 is movable along an X-axis and a Y-axis in a horizontal plane.

The machine controller 120 controls the machine actuator 110 and the laser processor 100A. The oscillator controller 12 of the laser processor 100A is connected to the machine controller 120 via a power line 79 to transmit electric power, which drives the machine controller 120, to the machine controller 120 by way of the power line 79. The oscillator controller 12 and the machine controller 120 are also connected via a signal line 87 to each transmit signals and receive signals by way of the signal line 87. The machine controller 120 transmits to the oscillator controller 12 by way of the signal line 87 the signals that control the laser processor 100A and the cooling device 50, while the oscillator controller 12 transmits to the machine controller 120 by way of the signal line 87 the signals indicating a state of the laser processor 100A and the state of the cooling device 50.

It is to be noted that the second primary power supply 52 may be connected to the machine controller 120. In that case, the machine controller 120 transmits, to the oscillator controller 12 by way of the power line 79, electric power that drives, for example, the oscillator controller 12. Alternatively, the second primary power supply 52 may be connected both to the oscillator controller 12 and to the machine controller 120.

The machine controller 120 is also connected to the machine actuator 110 via a power line 78 to supply, to the machine actuator 110 by way of the power line 78, electric power that drives the machine actuator 110. The machine controller 120 and the machine actuator 110 are also connected via a signal line 86 to each transmit a signal and receive a signal by way of the signal line 86. The machine controller 120 transmits to the machine actuator 110 by way of the signal line 86 the signal that controls the machine actuator 110, while the machine actuator 110 transmits to the machine controller 120 by way of the signal line 86 the signal indicative of a state of the machine actuator 110.

A description is provided here of a configuration of hardware that functionally implements the dehumidification controller 22 according to each of the first through third embodiments. The dehumidification controller 22 may be implemented by control circuitry, that is to say, a processor and a memory. The processor and the memory may be replaced by processing circuitry. Dedicated hardware, and software or firmware may each be partially responsible for functionally implementing the dehumidification controller 22.

The above configurations illustrated in the embodiments are illustrative of contents of the present invention, can be combined with other techniques that are publicly known and can be partly omitted or changed without departing from the gist of the present invention.

### REFERENCE SIGNS LIST

10 laser oscillator; 11 drive power supply; 12 oscillator controller; 20A to 20D dehumidifying apparatus; 21 dehumidifier; 22 dehumidification controller; 23 temperature sensor; 24 humidity sensor; 32A, 32B closed housing; 50 cooling device; 51 first primary power supply; 52 second primary power supply; 53 first breaker; 54 second breaker; 61 to 63 piping; 71 to power line; 81 to 87 signal line; 91 scheduler; 92 timer; 93 external communicator; 100A to 100D laser processor; 110 machine actuator; 111 transmission fiber; 112 machining head; 113 work table; 120 machine controller; 150 laser beam machine; W workpiece.

1. A laser processor comprising:
a laser oscillator housed in a housing;
an oscillator controller to control the laser oscillator and to be supplied with electric power by a first primary power supply;
a dehumidifier to operate using electric power supplied from a second primary power supply, the dehumidifier being housed in the housing; and
a dehumidification controller to control the dehumidifier and to be supplied with electric power by the second primary power supply.

2. The laser processor according to claim 1, wherein
the laser oscillator is water-cooled.

3. The laser processor according to claim 1, further comprising
a humidity sensor to detect an internal humidity of the housing, wherein
the humidity sensor operates using electric power supplied from the second primary power supply, and
the dehumidification controller controls the dehumidifier on a basis of a measurement result of the humidity sensor.

4. The laser processor according to claim 1, further comprising
a temperature sensor to detect an internal temperature of the housing, wherein
the temperature sensor operates using electric power supplied from the second primary power supply, and
the dehumidification controller controls the dehumidifier on a basis of a measurement result of the temperature sensor.

5. The laser processor according to claim 1, wherein
the dehumidifier includes an air-cooled dehumidification mechanism.

6. The laser processor according to claim 1, wherein
the dehumidification controller includes a scheduler to cause the dehumidifier to start dehumidification at a first preset date and time.

7. The laser processor according to claim 1, wherein
the dehumidification controller includes a timer to cause the dehumidifier to stop dehumidification at a second preset date and time.

8. The laser processor according to claim 1, wherein
the dehumidification controller controls the dehumidifier according to an instruction from an external communicator including a remote control function.

9. The laser processor according to claim 1, wherein
the first primary power supply is connected to the oscillator controller via a first breaker, and the second primary power supply is connected to the dehumidifier via a second breaker.

10. A laser beam machine comprising:
a laser processor to output a laser beam;
a machining processor to irradiate a workpiece with the laser beam when machining the workpiece;
a laser beam machine controller to control the laser processor and the machining processor;
a first primary power supply to supply the laser processor with electric power; and
a second primary power supply to supply the laser processor with electric power, wherein
the laser processor includes:
a laser oscillator to be water-cooled, the laser oscillator being housed in a housing;
an oscillator controller to control the laser oscillator and to be supplied with electric power by the first primary power supply;
a dehumidifier to operate using electric power supplied from the second primary power supply, the dehumidifier being housed in the housing; and
a dehumidification controller to control the dehumidifier and to be supplied with electric power by the second primary power supply.
